(19) United States
(12) Patent Application Publication
(10) Pub. No.: US 2017/0035031 A1
(43) Pub. Date: Feb. 9, 2017

(54) SYSTEM AND METHOD FOR CHICKEN FARMING

(71) Applicant: PLASSON LTD., D.N. Menashe (IL)

(72) Inventor: Yonatan BERNAT, D.N. Menashe (IL)

(73) Assignee: PLASSON LTD., D.N. Menashe (IL)

(21) Appl. No.: 15/303,045

(22) PCT Filed: Apr. 3, 2016
(86) PCT No.: PCT/IL2016/050359

§ 371 Date: Oct. 10, 2016

Related U.S. Application Data
(60) Provisional application No. 62/141,955, filed on Apr. 2, 2015.

(51) Int. Cl. A01K 31/22; C08L 97/02

(52) U.S. Cl. CPC A01K 31/22; C08L 97/02

(57) ABSTRACT

A system for chicken farming, comprising: a coop floor; at least one slat elevated from the coop floor; and a nesting cabin. The at least one slat is at least partially made of a natural fiber plastic composite (NFPC), such as a wood-plastic composite (WPC). In addition, a method for chicken farming using the system, and a wood-plastic composite for use in improving egg production performance in hens.

### CROSS-REFERENCE TO RELATED APPLICATIONS

This application claims the benefit of U.S. Provisional Patent Application No. 62/141,955, filed Apr. 2, 2015 and entitled “System and Method for Breeding Hens”, which is incorporated herein by reference in its entirety.

### FIELD OF THE INVENTION

The invention relates to the field of hen breeding in coops.

### BACKGROUND

The common egg-laying chicken coop (also “chicken house” or “chicken farm”) includes a floor and an elevated slat area that leads to laying cabins (also “nests” or “nesting cabins”), in which the hens lay their eggs. This structure tries to imitate nature, in which hens climb on bushes or trees on their way to an elevated nest where they safely lay their eggs, away from predators.

In commercial egg-laying chicken coops, much attention is given to every detail in the coop, in an attempt to improve the well-being of the hens and, as a result, the performance of the stock.

Commercial egg-laying chickens are generally divided into two types: Those commonly referred to as “light breeds”, which produce unfertilized eggs for eating, and those commonly referred as “heavy breeds” or “parent stock”, which produce fertilized eggs from which broiler chickens are hatched in a hatchery.

The light breeds are usually raised in female-only chicken coops, while the heavy breeds require the presence of some males in the coop in order for the females to produce fertilized eggs. The heavy breeds are also sometimes referred to as “parent stock”.

The raising of egg-laying chickens in coops is commonly termed “chicken farming”, a subcategory of poultry farming.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a system for chicken farming, comprising: a coop floor; at least one slat elevated from the coop floor; and a nesting cabin, wherein the at least one slat is at least partially made of a natural fiber plastic composite (NFPC).

A further embodiment provides a method comprising: farming chickens in a coop which comprises at least one slat that is at least partially made of a natural fiber plastic composite (NFPC), so as to improve egg production performance of the chickens.

Another embodiment provides a wood-plastic composite for use in improving egg production performance in hens.

Optionally, the nesting cabin is elevated above the at least one slat.

Optionally, the at least one slat is formed as a grid.

Optionally, the grid has bar widths and gaps sized to enable a hen to grip the bars with its claws and to comfortably stand and walk on the at least one slat.

Optionally, the at least one slat is entirely made of NFPC.

Optionally, the at least one slat is multiple slats.

Optionally, the at least one slat comprises a wood-plastic composite (WPC).

Optionally, the WPC comprises wood fibers and a polymer selected from the group consisting of: Polyethylene, Polypropylene, Polyvinyl Chloride, High-Density Polyethylene, Low-Density Polyethylene, Acrylonitrile Butadiene Styrene, Polystyrene, Polyamide, and Polylactic Acid.

Optionally, the wood fibers constitute 50-80 w % of the WPC, and the polymer constitutes 50-20 w % of the WPC.

Optionally, the egg production performance includes one or more parameters selected from the group consisting of: egg-laying rate, floor eggs rate, egg fertility rate, and egg hatching rate.

In addition to the exemplary aspects and embodiments described above, further aspects and embodiments will become apparent by reference to the figures and by a study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a general view of a coop, in accordance with some exemplary embodiments of the disclosure; and

FIG. 2 shows a schematic drawing of a slat, in accordance with some exemplary embodiments of the disclosure.

### DETAILED DESCRIPTION

Disclosed herein is a chicken farming system and method, which promote the well-being of female chickens (and optionally of any male chickens present) and thus their egg laying performance.

Some embodiments disclosed herein are for farming light breeds, while others are for farming heavy breeds.

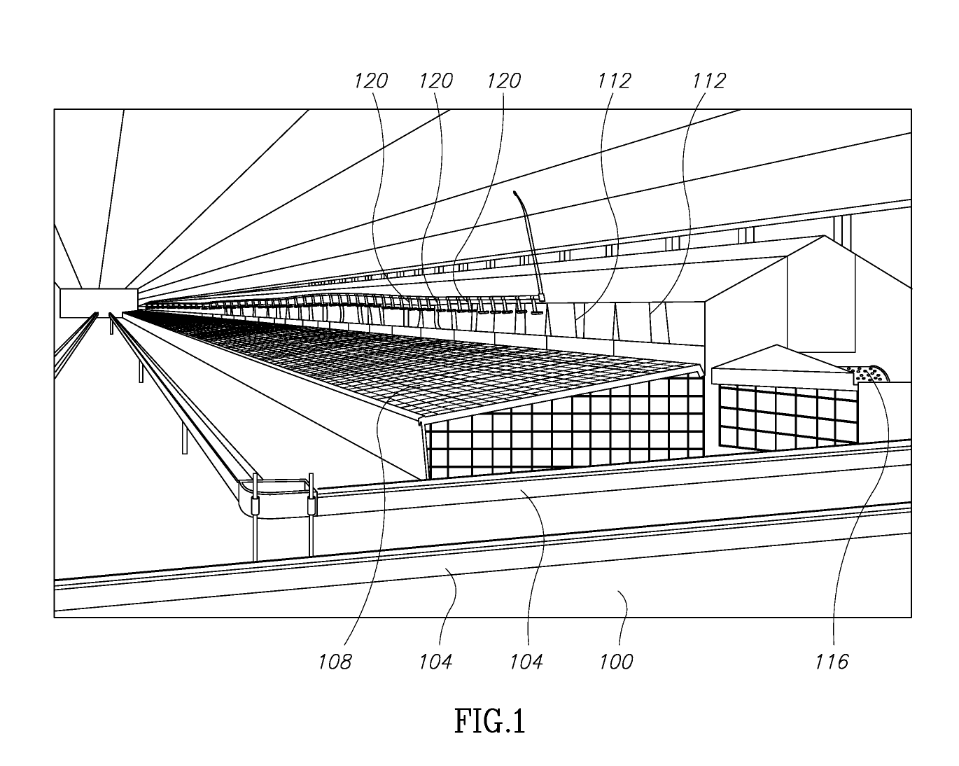

Referring to FIG. 1, a chicken coop may include a floor 100, on which trough-shaped feeding containers 104 and/or feeding plates (the latter are not shown) are typically placed; nesting cabins 112, where the female chickens (“hens”) lay their eggs; and a slat area 108 through which the hens access the nesting cabins and on which the hens await their turn to enter the nesting cabins.

Typically, slat area 108 is elevated above floor 100, and nesting cabins 112 are further elevated (or sometimes leveled with the slat area), in order to imitate a natural environment in which the hens climb on bushes/trees on their way to an elevated nest where they lay eggs.

When rearing hens, two important issues, are their well-being and their egg laying performance, wherein these issues are not unrelated. Research has shown an increase in egg laying rate in healthier hens living as comfortably as possible.

As further shown in FIG. 1 above, the hens are fed from containers 104 placed on floor 100 and drink water from watering containers 120. Floor 100 may be either the bare earth or a floored surface. The hens mostly lay their eggs in nesting cabins 112 having a downwards-inclined floor (not seen in the figure), such that the eggs roll over and arrive at egg collecting system 116.

The hens usually wait for laying their eggs on slat area 108. The waiting is needed since, in most coops, there is not a large enough number of nesting cabins to ensure wait-free usage thereof.

Slat area (or simply “slats”) 108 is generally shaped as a grid, in order for the hens to have a good grip of the slat's surface with their claws, comfortably stand and walk on the slats, and enable the stool and/or other dirt to fall down through the holes in the grid.

Slats 108 are generally elevated above floor 100 (or another base plane of the coop) but below the level of nesting cabins 112, to provide the hens with a natural-feeling environment.

In traditional coops, slats are typically made of either wood or plastic. Wood is more comfortable for the hens, improves their well-being and thus promotes their laying performance. However, wood is highly prone to environmental influences, rots quickly and is hard to clean. Plastic slats, on the other hand, are cheap, durable, and easy to clean and maintain. However, the synthetic material is uncomfortable for the hens and thus reduces their well-being and egg-laying performance.

Thus, in accordance with some embodiments of the disclosure, slats 108 may be made of one or more of a group of materials named natural fiber plastic composites (NFPCs), which may contain fiber fillers such as pulp fibers, peanut hulls, bamboo, straw, digestate, hemp, flax and/or the like. In some embodiments, the slats may be made of a specific group of NFPC, referred to as Wood-Plastic Composites (WPCs), also referred to as “wood grain plastic” or “wood grain extrusion”, which are composite materials made of wood fiber or wood flour and thermoplastic materials. WPCs have good workability and can be shaped using conventional woodworking tools. WPCs are often considered a sustainable material because they can be made using recycled plastics and the waste products of the wood industry. WPCs do not corrode and are highly resistant to rot, decay, and Marine Borer attack.

WPCs may be produced from either virgin or recycled thermoplastics including materials such as but not limited to Polyethylene (PE), Polypropylene (PP), Polyvinyl Chloride (PVC), High-Density Polyethylene (HDPE), Low-Density Polyethylene (LDPE), Acrylonitrile Butadiene Styrene (ABS), Polystyrene (PS), Polyamide, and Polylactic Acid or Polylactide (PLA), wherein PP-based WPCs are more common than others.

WPCs may be produced by thoroughly mixing ground wood particles and heated thermoplastic resin. The most common method of production is extruding the material into the desired shape, though injection molding is also used.

In some manufacturing facilities, the constituents may be combined and processed in a pelletizing extruder, which produces pellets of the new material. The pellets may thenbe re-melted and formed into the final shape. Other methods may include completing the finished part in a single step of mixing and extrusion.

Additives such as colorants, coupling agents, UV stabilizers, blowing agents, foaming agentsor lubricants may help adapt the end product to the target usage or area of application.

In some embodiments, slats 108 may be made of an NFPC which is a composite of natural fibers, such as hemp or flax, with bioplastics. Optionally, one or more different additives may be included in the composite. An exemplary such composite is the GreenLine composite produced by Jakob Winter GmbH of Nauheim, Germany.

Objects made of NFPC, such as slats, may be recycled easily in a new wood-plastic composite. NFPCmay be molded to meet almost any desired shape.

Thus, NFPC slats are easy to form, and provide the benefits of both plastic and wood. The slats are easy to clean and maintain like plastic, but, advantageously, feel natural for the hens and thus improve their well-being.

In some embodiments, slats 108 may be made of a WPC that contains between 20-70 w % polypropylene and 80-30 w % wood fiber, respectively. Optionally, the WPC also contains one or more additives which make up for between 1-5 w % of the composite, reducing the polypropylene and wood fiber contents accordingly. In a specific embodiment, slats 108 are made of a WPC consisting of 25-35 w % polypropylene, 65-75 w % wood fiber, and 0-5 w % of at least one additive. In another specific embodiment, slats 108 are made of a WPC consisting of 35-45 w % polypropylene, 55-65 w % wood fiber, and 0-5 w % of at least one additive. In another specific embodiment, slats 108 are made of a WPC consisting of 45-55 w % polypropylene, 45-55 w % wood fiber, and 0-5 w % of at least one additive. In another specific embodiment, slats 108 are made of a WPC consisting of 55-65 w % polypropylene, 35-45 w % wood fiber, and 0-5 w % of at least one additive. In another specific embodiment, slats 108 are made of a WPC consisting of 65-70 w % polypropylene, 30-35 w % wood fiber, and 0-5 w % of at least one additive. Optionally, the specific polymer-wood fiber ratio in the WPC is what causes the improvement over regular plastic slats.

In some embodiments, slats 108 span over at least 100 m² (square meters) of the coop's area (namely, of the coop's horizontal plane). In other embodiments, slats 108 span over at least 100 m² of the coop's area. In other embodiments, slats 108 span over at least 200 m² of the coop's area. In other embodiments, slats 108 span over at least 300 m² of the coop's area. In other embodiments, slats 108 span over at least 600 m² of the coop's area. In other embodiments, slats 108 span over at least 900 m² of the coop's area. In other embodiments, slats 108 span over at least 1500 m² of the coop's area. In other embodiments, slats 108 span over at least 2500 m² of the coop's area. In other embodiments, slats 108 span over at least 3500 m² of the coop's area. In other embodiments, slats 108 span over at least 4500 m² of the coop's area. In other embodiments, slats 108 span over at least 5500 m² of the coop's area.

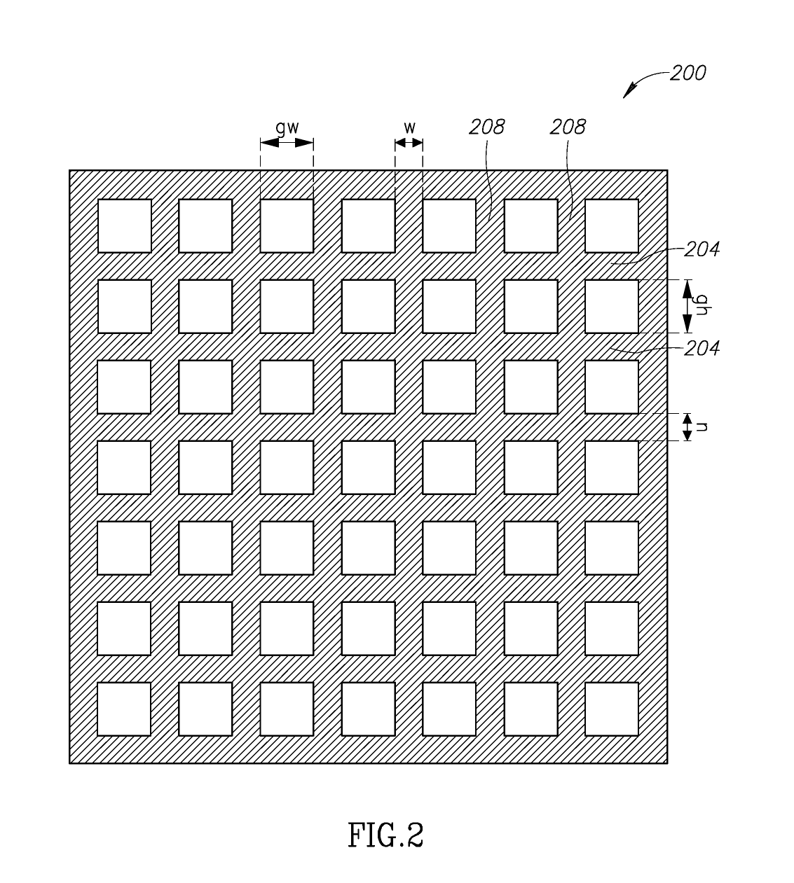

Referring now to FIG. 2, showing a top view of an exemplary slat 200 (one of slats 108 of FIG. 1), in accordance with some embodiments of the disclosure.

The exemplary slat 200 of FIG. 2 is a grid made of NFPC. The slat may be made of any required size. For example, each of the width and height of a slat may be between 30 centimeters (cm) and 150 cm. The grid may comprise horizontal bars 204 and vertical bars 208. Each bar of the grid may be of a width (indicated as ‘w’ or ‘h’, respectively) ranging between a few millimeters, such as 2 mm, and a few centimeters, such as 5 cm. The gaps (indicated as ‘gw’ or ‘gh’, respectively) between the bars may also be in substantially the same size range, but optionally of a larger or smaller size, for example between about 2 cm and about 5 cm. It will be appreciated that the width of each bar and the gaps between bars may be such that a hen may get a good grip of the bars with its claws.

It will also be appreciated that not all bars and all gaps need to be uniform. Rather, some bars may be thicker or thinner than others and some gaps may be larger or smaller than others. Further, the bar width and the gaps are not necessarily identical for the two dimensions, but the width(s) or gap(s) in one direction may be different than in the other direction.

The thickness of horizontal bars 204 and vertical bars 208, which is not observable in the figure, may be between 1 cm and 10 cm as required to be strong and rigid enough to carry the weight of the hens as well as of the workers walking on the slat surface.

Multiple slats, such as slat 200, may be connected to each other to form slat area 108 of FIG. 1 using any desired mechanism, such as various fasteners. Alternatively, the slats may be placed on corresponding structures such that the slats do not connect to each other but are rather placed next to each other and supported by the underlying structure.

It will be appreciated that slat 200 shown in FIG. 2 is exemplary only and that any other grid structure may be used, such as a grid comprising triangular holes, hexagonal holes, octagonal holes, diamond-shaped holes, or the like. Generally, each slat may be a board having holes that penetrate its entire thickness.

Using NFPC as the material for manufacturing the slats of a coop has shown surprising results and has proven beneficial for improving the egg laying performance of hen. This may be attributed to the natural feeling provided by the NFPC slats, which promotes the well-being of the hens.

It will be appreciated that each slat may be made of a multiplicity of parts or members, in which some parts or members are made of NFPC while others are made of other material such as plastic. In some embodiments, the top parts of the slats—the ones whose texture can be felt by the hens—may be made of NFPC, while other parts which are less likely to be touched by the hen may be made of other materials, which may be cheaper, stronger or the like.

It will be appreciated that the disclosure covers also a method comprising providing slats made at least partially of NFPC (or, more specifically, WPC), and a method comprising providing, assembling and/or manufacturing a hen coop that contains such slats. Also included herein is a method for improving egg production performance of hens in a coop, the method comprising the use of NFPC (or, more specifically, WPC). The NFPC may be used in one or more slats in the coop, up to the entirety of the slats in the coop. Further included is a composition of matter, such as NFPC (or, more specifically, WPC), for use in improving egg production performance of hens in a coop.

The egg production performance may improve in one or more of the following parameters: egg-laying rate, floor eggs rate, egg fertility rate, and egg hatching rate. These parameters are further discussed in the experimental results section, below.

In some embodiments, the egg-laying rate is increased by at least 3%, at least 5%, at least 7%, at least 9%, or at least 15% with respect to a comparable coop equipped with plastic-only slats.

In some embodiments, the floor eggs rate is reduced by at least 10%, at least 20%, at least 30%, at least 40%, or at least 50% with respect to a comparable coop equipped with plastic-only slats.

In some embodiments, the fertile eggs rate is increased by at least 1%, at least 3%, at least 5%, at least 7%, or at least 11% with respect to a comparable coop equipped with plastic-only slats.

In some embodiments, the egg hatching rate is increased by at least 1%, at least 3%, at least 5%, at least 7%, at least 9%, at least 11%, or at least 15% with respect to a comparable coop equipped with plastic-only slats.

### Experimental Results

To evaluate the performance of NFPC slats in egg-laying chicken coops, a chicken coop in the Ta'anakh region, Israel, which was equipped with standard plastic slats when raising a previous year's stock, underwent a complete replacement of those slats with NFPC slats. Particularly, the NFPC slats were made of Polywood C4 70 PP 10150, a material provided by Advanced Compounding Rudolstadt GmbH, Germany. This material is a natural fiber-reinforced polymer, which contains of about 70 w % (volumetric percentage) wood fiber, about 28 w % polypropylene and additives, and about 2 w % masterbatch white. The wood fibers generally have a length of between approximately 500 micrometers and 900 micrometers, and a maximum diameter of between approximately 300 and 400 micrometers. The material was provided as granules and was molten and injection-molded to form slats similar in shape to the slat shown in FIG. 2.

Performance in the experimental (NFPC slats) coop was compared against performance of the same coop in the previous year (plastic slats), serving as the control group in the experiment. All other parameters remained substantially the same: a 12000-heavy-breed occupant count, the season of the year, the general structure of the coop (including slat elevation from the ground, the same nesting cabins, the same food/drink locations, etc.), the chicken breed used (Ross 308 by Aviagen Group, Germany), the feeding regime, the training regime, etc.

Table 1 shows an egg-laying rate comparison of the experimental coop vs. the control coop. The egg-laying rate is computed, as acceptable in the industry, as the total number of hens in the coop divided by the total number of eggs laid in the time period measured (one week in this table). The table also shows the industry performance objectives for the Ross 308 breed provided by Aviagen Group. See Aviagen Group, “Parent Stock Performance Objectives”, June 2011, available online at http://en.aviagen.com/assets/Tech_Center/Ross_PS/Ross-308-PS-PO-2011.pdf, last viewed on Mar. 28, 2016.

TABLE 1
Egg-laying rate comparison

| | | | | | Percent |
|---|---|---|---|---|---|
| | | | | | change |
| | | | | Percent | between |
| | | | | change | Experimental |
| | Egg-laying rate (%) | | | between | and |
| | Exper- | | Performance | Experimental | Performance |
| Week | imental | Control | Objectives | and Control | Objectives |
| 26 | 58.47 | 64.1 | 22.3 | −8.78% | 162.20% |
| 27 | 78.59 | 81.41 | 52.5 | −3.46% | 49.70% |
| 28 | 87.32 | 86.43 | 74.21 | 1.03% | 17.67% |
| 29 | 89.54 | 87.04 | 83 | 2.87% | 7.88% |
| 30 | 89.81 | 86.65 | 86.1 | 3.65% | 4.31% |
| 31 | 89.23 | 85.61 | 86.9 | 4.23% | 2.68% |
| 32 | 90.32 | 85.4 | 86.4 | 5.76% | 4.54% |
| 33 | 89.33 | 85.09 | 85.4 | 4.98% | 4.60% |
| Average | 89.25 | 86.03 | 83.66 | 3.75% | 6.95% |
| wk. 28-33 | | | | | |

As visible in Table 1, the experimental coop provided a better egg-laying rate than both the control group and the Aviagen Group performance objectives over a period of eight consecutive weeks (28 to 33). Collection of experimental data ceased after week 33. The weeks are counted since the hatching of the hens. Performance in weeks 26-27 has little or no relevancy, as is well known in the industry; during the first two weeks of egg-laying, most if not all eggs are discarded due to their low quality and other factors. It is common to only count the 28^{th} week and onwards for performance calculation purposes. On average, in weeks 28 to 33, the experimental coop performed 3.75% better than the control coop, and 6.95% better than performance objective. When translated into the huge numbers of eggs laid weekly in commercial hen coops, this increased performance of the experimental coop translates into considerable gain.

Table 2 shows a floor eggs rate comparison of the experimental coop vs. the control coop and the industry performance objectives. The floor egg rate is computed as the percentage of eggs laid by the hens outside the nesting cabins, such as on the coop's floor, out of the total of eggs laid in the coop. This is an industry-accepted measure of the well-being of the hens as well as the efficacy of the coop's structure. Floor eggs require manual collection which is labor-intensive. Additionally, floor eggs are commonly prone to contamination (e.g., from the hens' fecal matter) and usually have to be separated, when packaged, from the eggs laid in the nesting cabins, to avoid infection.

TABLE 2
Floor eggs rate comparison

| | | | Percent change between |
|---|---|---|---|
| | Floor eggs rate (%) | | Experimental and |
| Week | Experimental | Control | Control |
| 26 | 7 | 12 | −42% |
| 27 | 3.5 | 7.5 | −53% |
| 28 | 2.2 | 4.5 | −51% |
| 29 | 2.2 | 3.7 | −41% |
| 30 | 2.3 | 3.5 | −34% |
| 31 | 2.2 | 3.3 | −33% |
| 32 | 2.1 | 3.3 | −36% |
| 33 | 2.2 | 3.4 | −35% |
| Average wk. | 2.2 | 3.61 | −38% |
| 28-33 | | | |

As visible in Table 2, the experimental coop provided a much lower floor eggs rate than the control group over a period of eight consecutive weeks (28 to 33). Collection of experimental data ceased after week 33. On average, in weeks 28 through 33, the experimental coop saw a reduction of 38% in floor eggs compared to the control coop. This increased performance of the experimental coop translates into a considerable gain, reduces manual labor and reduces egg infection rates.

Table 3 shows an egg fertility rate comparison of the experimental coop vs. the control coop and the industry performance objectives. The fertility rate is computed as the percentage of fertile eggs out of the entirely of laid eggs during the period. When a coops is used for parent stock, the fertility rate is naturally of great importance.

TABLE 3
Fertile eggs rate comparison

| | | | | | Percent |
|---|---|---|---|---|---|
| | | | | | change |
| | | | | Percent | between |
| | | | | change | Experimental |
| | Fertile eggs rate (%) | | | between | and |
| | Experi- | | Performance | Experimental | Performance |
| Week | mental | Control | Objectives | and Control | Objectives |
| 27 | 79 | 77 | 78 | 2.60% | 1.28% |
| 28 | 82 | 79 | 81 | 3.80% | 1.23% |
| 29 | 86 | 82.5 | 84 | 4.24% | 2.38% |
| 30 | 87 | 83 | 85 | 4.82% | 2.35% |
| 31 | 88 | 85 | 87 | 3.53% | 1.15% |
| Average | 84.4 | 81.3 | 83 | 3.81% | 1.69% |
| wk. 27-31 | | | | | |

As visible in Table 3, the experimental coop provided a higher rate of fertile eggs than the control group over a period of five consecutive weeks (28 to 31). Collection of experimental data ceased after week 31. On average, in weeks 28 through 31, the experimental coop saw 3.81% more fertile eggs that the control coop, and 1.69% more than the performance objectives. This means that more eggs of the ones laid out in the coop are usable for a later hatching in a hatchery, to produce broiler chicks. Combined with the enhanced egg-laying rate presented above, the experimental coop provided a significantly higher number of fertile eggs than the control and the performance objectives. Also observed was a considerable increase in the hatching rates of eggs from the experimental coop compared with the control coop. The hatching rate is compared as the number of hatched eggs out of the number of fertile eggs laid.

The materials, methods and improvements presented above in the framework of the experimental results section are considered to be embodiments of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1.-23. (canceled)

24. A system for chicken farming, comprising:
a coop floor;
at least one slat elevated from the coop floor; and
a nesting cabin,
wherein the at least one slat is at least partially made of a natural fiber plastic composite (NFPC).

25. The system of claim 24, wherein the nesting cabin is elevated above the at least one slat.

26. The system of claim 24, wherein the at least one slat is formed as a grid.

27. The system of claim 26, wherein the grid has bar widths and gaps sized to enable a hen to grip the bars with its claws and to comfortably stand and walk on the at least one slat.

28. The system of claim 24, wherein the at least one slat is entirely made of NFPC.

29. The system of claim 24, wherein the at least one slat comprises a wood-plastic composite (WPC).

30. The system of claim 29, wherein the WPC comprises wood fibers and a polymer selected from the group consisting of: Polyethylene, Polypropylene, Polyvinyl Chloride, High-Density Polyethylene, Low-Density Polyethylene, Acrylonitrile Butadiene Styrene, Polystyrene, Polyamide, and Polylactic Acid.

31. The system of claim 30, wherein the wood fibers constitute 30-80 w % of the WPC, and the polymer constitutes 70-20 w % of the WPC.

32. A method comprising:
farming chickens in a coop which comprises at least one slat that is at least partially made of a natural fiber plastic composite (NFPC), so as to improve egg production performance of the chickens.

33. The method of claim 32, wherein the egg production performance includes one or more parameters selected from the group consisting of: egg-laying rate, floor eggs rate, egg fertility rate, and egg hatching rate.

34. The method of claim 32, wherein the at least one slat is multiple slats, and wherein the coop further comprises a floor on which a feeding container is located and a nesting cabin, such that the multiple slats are elevated relatively to the floor and the nesting cabin is elevated relatively to the multiple slats.

35. The method of claim 34, wherein each of the multiple slats is formed as a grid.

36. The method of claim 35, wherein the grid has bar widths and gaps that enable a hen to grip the bars with its claws.

37. The method of claim 32, wherein the at least one slat is entirely made of NFPC.

38. The method of claim 32, wherein the at least one slat comprises a wood-plastic composite (WPC), and wherein the WPC comprises wood fibers and a material selected from the group consisting of: Polyethylene, Polypropylene, Polyvinyl Chloride, High-Density Polyethylene, Low-Density Polyethylene, Acrylonitrile Butadiene Styrene, Polystyrene, Polyamide, and Polylactic Acid.

39. The method of claim 38, wherein the wood fibers constitute 30-80 w % of the WPC, and the polymer constitutes 70-20 w % of the WPC.

40. A wood-plastic composite for use in improving egg production performance in hens.

41. The wood-plastic composite of claim 40, wherein the egg production performance includes one or more parameters selected from the group consisting of: egg-laying rate, floor eggs rate, egg fertility rate, and egg hatching rate.

42. The wood-plastic composite of claim 40, comprising wood fibers and a polymer selected from the group consisting of: Polyethylene, Polypropylene, Polyvinyl Chloride, High-Density Polyethylene, Low-Density Polyethylene, Acrylonitrile Butadiene Styrene, Polystyrene, Polyamide, and Polylactic Acid.

43. The wood-plastic composite of claim 42, wherein the wood fibers constitute 30-80 w % of the wood-plastic composite, and the polymer constitutes 70-20 w % of the wood-plastic composite.
